(19) United States
(12) Patent Application Publication
(10) Pub. No.: US 2007/0279811 A1
(43) Pub. Date: Dec. 6, 2007

(54) Protection device

(75) Inventors: Weesyk Wang, Taipei (TW); Michael Yang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/445,826

(22) Filed: Jun. 1, 2006

(51) Int. Cl. H02H 3/00

(52) U.S. Cl. 361/1

(57) ABSTRACT

A protection device applicable to an electronic device is disclosed. The electronic device includes an operating unit which outputs an on/off signal when a user turns on/off the electronic device is disclosed. The protection device includes a setting unit for setting a predetermined period, and a processing unit electrically connected to the operating unit and the setting unit. The processing unit outputs a trigger signal to turn on/off the electronic device when receiving an on/off signal provided by the operating unit during the predetermined period, and no longer outputs any trigger signal when receiving the on/off signal again during the predetermined period.

### BACKGROUND OF THE INVENTION

1. Field of the Invention

The present invention relates to protection devices, and more particularly, to a protection device which avoids circuit damage, misoperation and downtime of an electronic device induced by continuously turning on and off in a determined time an operating unit which controls the power of the electronic device.

2. Description of Related Arts

As is known, when a button of an electronic device is pressed, a trigger signal is produced to turn on a corresponding timing operation of the electronic device, whereas how to effectively eliminate bounce of a button is a long-term subject in the electronic field.

The bounce of a button is classified into a mechanical bounce and a manmade bounce. The mechanical bounce is caused by mechanical structure of the button. That is to say, continuous and instantaneous on and off may be produced to trigger the electronic device, thereby circuit damage and misoperation of the electronic device may occur. The manmade bounce refers to frequently pressing the button in a short time by a user, which may also result in circuit damage and misoperation.

To take a power button of a Notebook as an example, the conventional method for debounce adopts an RC filter with embedded controller (EC) software on a mainboard. Referring to FIGS. 1A and 1B, a button pulse signal (PWIN) of a power button (SW1) is transmitted to an EC 11 through an RC circuit (composed of a resistor R2 and a capacitor C2). A debounce program in the EC 11 eliminates the bounce of the button pulse signal (PWIN) and then triggers a system on chip (SOC) 12 to start a power on timing and execute a corresponding operation.

However, as the EC 11 is generally a 16-bit Micro Control Unit (MCU) with short timing pulse, the debounce program can only eliminate bounce in tens of millisecond (ms), thereby the aforementioned method can only eliminate bounce caused by the mechanical bounce and can not be applied to eliminating bounce caused by the manmade bounce because a time interval of the manmade bounce is as high as hundreds of milliseconds. Therefore, pressing power button continuously may induce misoperation of system power on timing, cause circuit damage or misoperation, and more seriously result in system downtime.

Furthermore, the debounce time range is fixed because the debounce program is stored in the EC 11, so a software designer must rewrite the debounce program according to different Notebook and button with different bounce time range, thereby complexity of software design is increased.

As a result, the present subject to be solved is to provide a protection device which can avoid the defects of the prior art without software controlling.

### SUMMARY OF THE INVENTION

In views of the above-mentioned problems of the prior art, it is a primary objective of the present invention to provide a protection device which avoids circuit damage, misoperation and downtime of an electronic device induced by continuous turns on/off an operating unit which controls the power of the electronic device in a determined time.

It is another objective of the present invention to provide a protection device without software design, thus it can be applied to different types of electronic devices.

To achieve the above-mentioned and other objectives, a protection device applicable to an electronic device is provided in the present invention. The electronic device includes an operating unit which outputs an on/off signal when a user turns on/off the electronic device is disclosed. The protection device includes a setting unit for setting a predetermined period of time, and a processing unit electrically connected to the operating unit and the setting unit. The processing unit outputs a trigger signal to turn on/off the electronic device when receiving an on/off signal provided by the operating unit during the predetermined period of time, and no longer outputs any trigger signal when receiving the on/off signal again during the predetermined period of time.

In one preferred embodiment, the processing unit is a signal processor which is a dual retriggerable monostable multivibrator typed as DM74LS123. The trigger signal is a low pulse signal. Moreover, the setting unit is a setting circuit consisted of a resistance and a capacitance, and the predetermined period is determined by the resistance value and the capacitance value, that is to say, the predetermined period is equal to a charging and discharging time value of the resistance and the capacitance.

Compared with the prior art, through operation between the setting unit and the processing unit, the protection device of the present invention can transfer a multi-pulse on/off signal which is produced by continuous pressing the power button in a determined time to a single-pulse signal which triggers the electronic device to do a normal power switching operation.

Furthermore, the hardware circuit of the present invention is simple and can be applied to different electronic devices only by changing the charging and discharging time value of the resistance and the capacitance, thus the software design of the electronic device is simplified.

### BRIEF DESCRIPTION OF DRAWINGS

The invention can be more fully understood by reading the following detailed description of the preferred embodiments, with reference made to the accompanying drawings, wherein:

FIG. 1A (PRIOR ART) is a functional block diagram of a debounce system of the prior art;

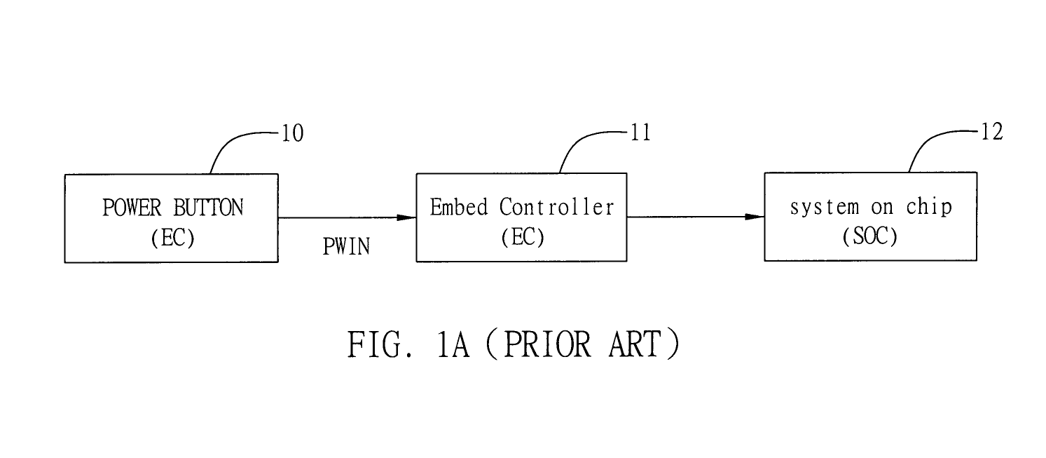

FIG. 1B (PRIOR ART) is an embodiment showing an input circuit of a power button according to FIG. 1A;

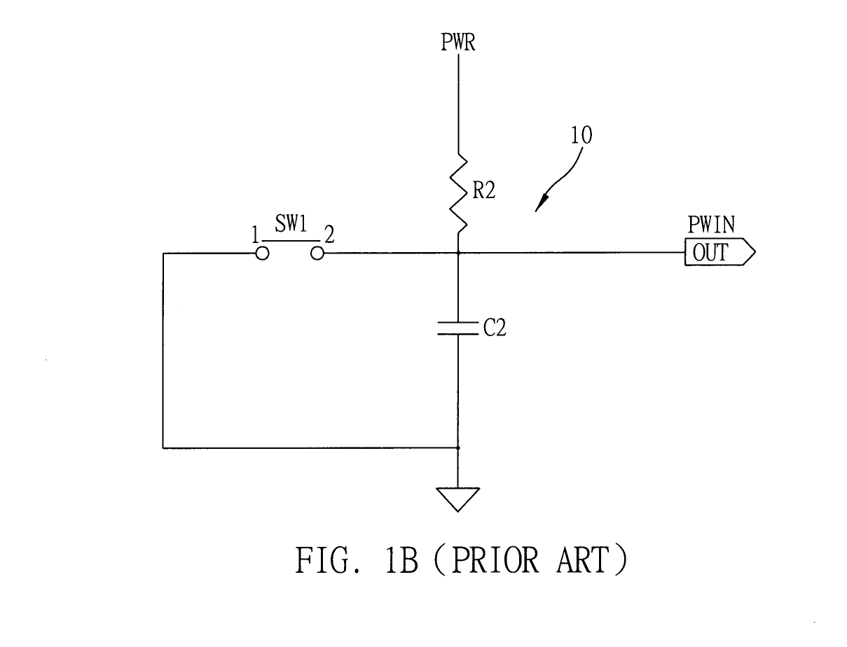

FIG. 2A is a functional block diagram of a protection device according to the present invention;

FIG. 2B is an embodiment showing a detailed circuit of a protection device according to the present invention; and

FIG. 3 is a timing diagram showing a relationship between an on/off signal (PWIN) and a single-pulse signal (PWRBT) of the protection device shown in FIG. 2B.

### DETAILED DESCRIPTION OF PREFERRED EMBODIMENTS

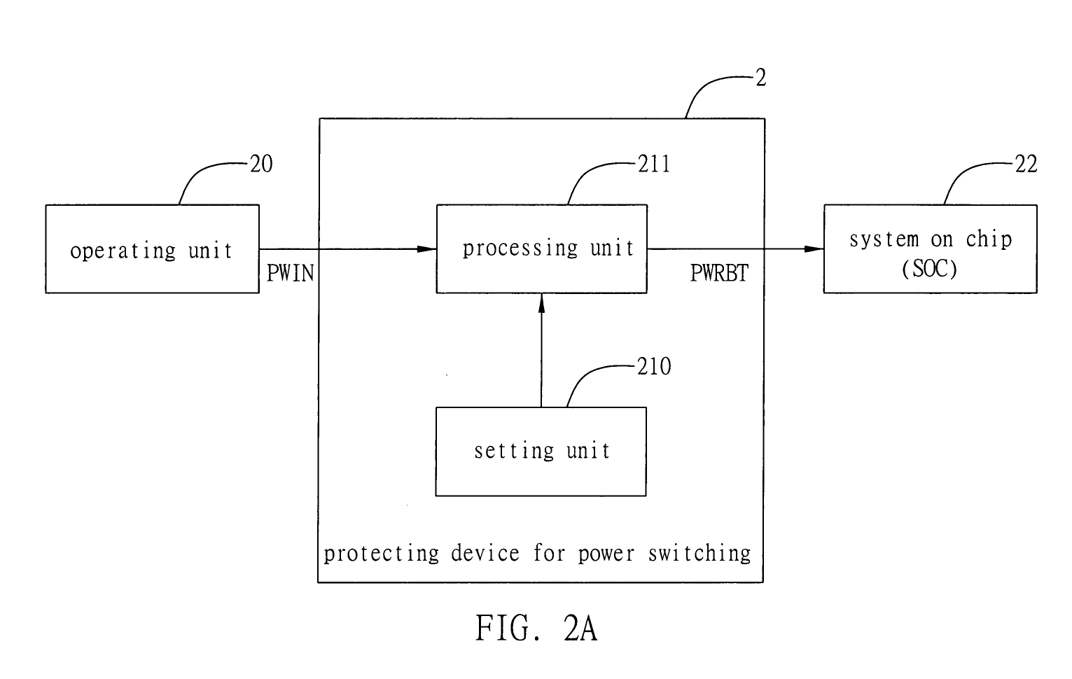

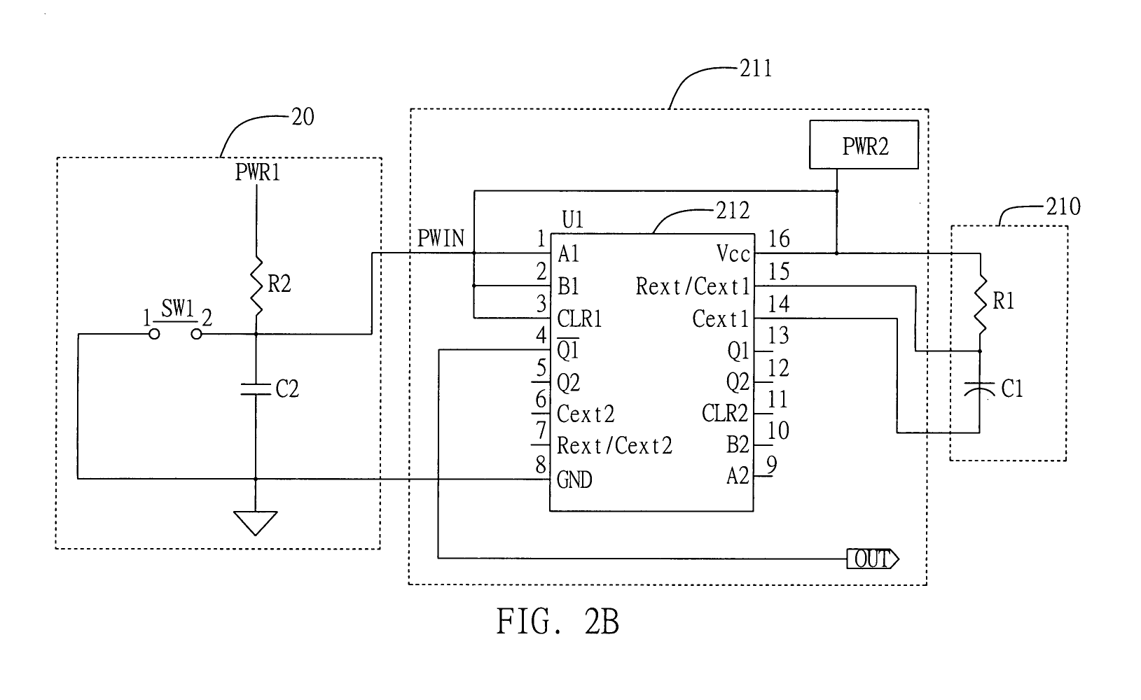

FIG. 2A is a functional block diagram of an operating unit 20, a system on chip (SOC) 22 and a protection device 2 for power switching according to the present invention. The protection device 2 is applicable to an electronic device (not shown), such as a Notebook computer, a personal computer (PC), a server and so on. The electronic device includes the operating unit 20 and the SOC 22. The operating unit 20 is for a user to turn on or turn off the electronic device. The operating unit 20 outputs an on/off signal when the user turns on/off the electronic device. In the present embodiment, the operating unit 20 is a power button, and outputs an on/off signal (PWIN) which is a low-leveled pulse signal when the power button is pressed.

As shown in FIG. 2A, the protection device 2 comprises a setting unit 210 and a processing unit 211.

The setting unit 210 is used for setting a predetermined period (T). The setting unit 210 is a setting circuit composed of a resistor and a capacitor. The predetermined period (T) is determined by the resistance of the resistor and the capacitance of the capacitor. That is to say, the predetermined period (T) can be changed according to actual requirements by changing a charging and discharging time value of the resistor and the capacitor.

The processing unit 211 is electrically connected to the operating unit 20 and the setting unit 210. The processing unit 211 outputs a trigger signal to turn on/off the electronic device when receiving the on/off signal output by the operating unit 20 for the first time during the predetermined period (T). On the other hand, when receiving another on/off signal during the predetermined period (T), the processing unit 211 no longer outputs any trigger signal. More particularly, the processing unit 211 produces a single-pulse signal (PWRBT) which is a low pulse signal to trigger the SOC 22 of the electronic device to start a power on timing and do a corresponding power switching operation when receiving the on/off signal (PWIN) of the power button for the very first time during the predetermined period (T). In the present embodiment, the processing unit 211 is a signal processor, for example, a dual retriggerable monostable multivibrator typed as DM74LS123; additionally, the power of the processing unit 211 (the signal processor) is provided by the electronic device or an extra power supply.

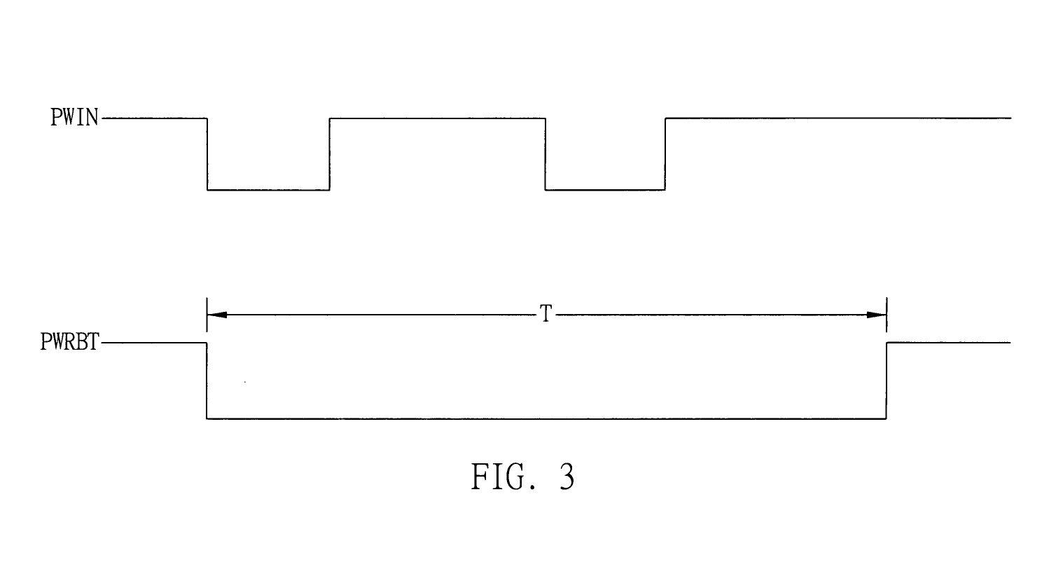

A preferred circuit structure of the protection device 2 is illustrated in the following description in conjunction with FIG. 2B and 3. FIG. 2B is an embodiment showing a detailed circuit of the protection device 2 according to the present invention. FIG. 3 is a timing diagram showing a relationship between the on/off signal (PWIN) and the single-pulse signal (PWRBT) of the protection device 2 shown in FIG. 2B.

As shown in FIG. 2B, the on/off signal (PWIN) is produced when the operating unit 20 of the electronic device is pressed. As shown in the figure, the operating unit 20 includes a power button (SW1) and an RC filter circuit composed of a resistor (R2) and a capacitor (C2). One end of the power button (SW1) and one end of the capacitor (C2) are connected to ground. One end of the resistor (R2) is connected to a power source (PWR1). When the user presses the operating unit 20 to turn on the electronic device, the power button (SW1) of the operating unit 20 is closed, and the on/off signal (PWIN) which is a low pulse signal is produced and output to the processing unit 211.

The processing unit 211 is a signal processor 212. A power (PWR2) is further provided for the signal processor 212. In the present embodiment, the signal processor 212 is a dual retriggerable monostable multivibrator typed as DM74LS123.

As shown in FIG. 2B, an input pin (A1) of the signal processor 212 is used for receiving the on/off signal (PWIN) of the operating unit 20; input pins (B1), (CLR1) and (VCC) are connected to the power (PWR2); and a pin ( Q̅1̅) is an output pin.

One end of a resistor (R1) of the setting unit 210 is connected to the power (PWR2), and the other end of the resistor (R1) is connected to a pin (Rext/Cext1) of the DM74LS123; one end of a capacitor (C1) is connected to a pin (Cext1) of the DM74LS123, and the other end of the capacitor (C1) is connected to the pin (Rext/Cext1) of the DM74LS123.

It should be noted that in the prior art a single-low-pulse signal is produced by the operating unit 20 when the user presses the operating unit 20 of the electronic device. However a plurality of multi-low-pulse signals which may result in circuit damage, misoperation and downtime of the electronic device are produced if the user continuously presses the operating unit 20.

As shown in FIG. 3, when the user presses the operating unit 20 a plurality of times continuously, the multi-low-pulse signal (PWIN) mentioned above is produced by the operating unit 20 and output to the pin (A1) of the signal processor (DM74LS123) 212. Then a first falling-edged signal of the on/of signal (PWIN) triggers the single-pulse signal (PWRBT) to generate a low pulse signal, which has a pulse width equal to the predetermined period (T) set by the setting unit 210. For example, the predetermined period (T) calculated based on the resistor (R1) and the capacitor (C1) is as long as 1.9 seconds. That is to say, the signal processor 212 transfers the on/off signal (PWIN) for the first time to the low-pulse signal (PWRBT) during 1.9 second. Therefore, the electronic device only starts the system power on timing once even if the user continuously presses the operating unit 20 during the 1.9 seconds. Because the predetermined period (T) 1.9 seconds is long enough for the the system power on timing to be executed completely, system downtime can be prevented from occurrence.

The functions of the signal processor (DM74LS123) 212 are described as follows: when the input pins (B1) and (CLR1) are high (connected to the power PWR2), if the input pin (A1) produces a first falling-edged signal, the output pin (/Q1) is triggered to output a low-pulse signal, which has a width calculated based on the resistor (R1) and the capacitor (C1) of the setting unit 210; and the output pin (/Q1) is no longer triggered by continuous high to low edges of the input pin (A1) in the predetermined period set by the setting unit 20. In other words, only the first falling-edged signal of the on/off signal (PWIN) can trigger a low-pulse signal (PWRBT) even if the on/off signal (PWIN) has a plurality of falling-edged signals (produced by mechanical bounce or continuous pressing the operating unit 20).

As a result, the protection device of the present invention can eliminate the button debounce caused by mechanical bounce or manmade bounce through the processing unit which is a dual retriggerable monostable multivibrator typed as DM74LS123 and a setting unit which is consisted of a resistance and a capacitance, and change debounce time range by changing the charging and discharging time value of the resistance and the capacitance. Therefore, the present invention can eliminate not only mechanical bounce but also manmade bounce through the simple circuit structure; meanwhile, software controlling is not needed by using the protection device of the present invention, thus the debounce program can also be omitted to simplify the software design of the electronic device.

In summary, the foregoing descriptions are only the preferred embodiment and not restrictive of the technical scope of the present invention. The essential technical contents of the present invention are widely defined in the appended claims. All embodiments or methods accomplished by others which are the same as the definitions of the following claims or other equivalents should be considered as falling within the scope of the claims.

What is claimed is:

1. A protection device applicable to an electronic device having an operating unit which outputs an on/off signal when a user turns on/off the electronic device, the protection device comprising:
a setting unit for setting a predetermined period of time; and
a processing unit electrically connected to the operating unit and the setting unit, for outputting a trigger signal to turn on/off the electronic device when receiving an on/off signal provided by the operating unit during the predetermined period of time, and no longer outputting any trigger signal when receiving the on/off signal again during the predetermined period of time.

2. The protection device of claim 1, wherein the electronic device is a Notebook computer.

3. The protection device of claim 1, wherein the operating unit is a power button.

4. The protection device of claim 1, wherein the on/off signal is a low-leveled pulse signal.

5. The protection device of claim 1, wherein the setting unit is a setting circuit composed of a resistor and a capacitor.

6. The protection device of claim 5, wherein the predetermined period of time is determined by a resistance of the resistor and a capacitance of the capacitor.

7. The protection device of claim 5, wherein the predetermined period of time has a value equal to a charging and discharging time value of the resistor and the capacitor.

8. The protection device of claim 1, wherein the processing unit is a signal processor.

9. The protection device of claim 8, wherein the signal processor is a dual retriggerable monostable multivibrator typed as DM74LS123.

10. The protection device of claim 9, wherein the trigger signal is a low-leveled pulse signal.

11. The protection device of claim 8, wherein the electronic device supplies power to the signal processor.

12. The protection device of claim 8, wherein power of the signal processor is provided by an extra power supply.
